(19) United States
(12) Patent Application Publication
(10) Pub. No.: US 2023/0385118 A1
(43) Pub. Date: Nov. 30, 2023

(54) SELECTIVE EXECUTION OF WORKLOADS USING HARDWARE ACCELERATORS

(71) Applicant: Microsoft Technology Licensing, LLC, Redmond, WA (US)

(72) Inventors: John Allen TARDIF, Bellevue, WA (US); Bharadwaj PUDIPEDDI, San Jose, CA (US)

(21) Appl. No.: 18/324,646

(22) Filed: May 26, 2023

(51) Int. Cl. G06F 9/50

(52) U.S. Cl. CPC G06F 9/5044; G06F 9/5038

(57) ABSTRACT

Systems and methods for selective execution of workloads using hardware accelerators are described. A method includes a client application submitting a command for execution of a workload directly to a hardware accelerator, where the command includes an indication of a performance expectation from the hardware accelerator, and where the workload can be executed either by a compute core accessible to the client application or by the hardware accelerator. The method further includes upon receiving a retry response from the hardware accelerator, the client application executing the workload using the compute core accessible to the client application, where the hardware accelerator is configured to provide the retry response directly to the client application after determining that the hardware accelerator is unable to meet the performance expectation.

### BACKGROUND

Client applications can be run in virtual environments hosted by servers or other computers. As an example, resources including compute cores, memory, and input/output (IO) resources are allocated to the virtual machines, allowing them to execute client applications using one or more compute cores associated with the respective server. Certain workloads, while being able to run on the allocated compute cores, are inefficient for execution by the compute cores due to the compute core architecture and/or the nature of the algorithms used in these workloads.

Certain computing environments include hardware accelerators that can execute these workloads more efficiently. While the workloads can be executed more efficiently using the hardware accelerators, the decisions regarding whether to offload a particular workload from the compute core to a hardware accelerator are still inefficient. Thus, there is a need for improved methods and systems for deciding when the execution of workloads that can be potentially offloaded to the hardware accelerators ought to be offloaded from the compute core.

### SUMMARY

One aspect of the present disclosure relates to a method comprising a client application submitting a command for execution of a workload directly to a hardware accelerator, where the command includes an indication of a performance expectation from the hardware accelerator, and where the workload can be executed either by a compute core accessible to the client application or by the hardware accelerator. The method may further include upon receiving a retry response from the hardware accelerator, the client application executing the workload using the compute core accessible to the client application, where the hardware accelerator is configured to provide the retry response directly to the client application after determining that the hardware accelerator is unable to meet the performance expectation.

In another aspect, the present disclosure relates to a method comprising allowing client applications executing in a user space associated with a virtual computing environment to access an accelerator portal for a hardware accelerator capable of executing workloads that can be executed either by a compute core accessible to a client application or by the hardware accelerator. The method may further include the hardware accelerator providing performance data to the accelerator portal.

The method may further include, after the client application evaluating the performance data obtained from the accelerator portal and determining that execution of the workload using the compute core would take less time than executing the workload using the hardware accelerator, the client application executing the workload using the compute core accessible to the client application.

In yet another aspect, the present disclosure relates to a system comprising an accelerator portal to allow a plurality of client applications access to one or more of a plurality of shared hardware accelerators, where each of the plurality of client applications can execute a workload using a compute core or by using one of the plurality of shared hardware accelerators. The system may further include a hardware accelerator, from among the plurality of shared hardware accelerators, configured to receive from a client application a command for execution of a workload via a shared bus system coupled to the compute cores and the plurality of shared hardware accelerators, where the command includes an indication of a performance expectation from the hardware accelerator, and where the workload can be executed either by a compute core accessible to the client application or by the hardware accelerator.

The client application may be configured to execute the workload using the compute core accessible to the client application upon receiving a retry response from the hardware accelerator, where the hardware accelerator is configured to provide the retry response directly to the client application after determining that the hardware accelerator is unable to meet the performance expectation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows a block diagram of a system for selective execution of workloads using hardware accelerators in accordance with one example;

FIG. 2 shows a block diagram of an example hardware acceleration system for use with the system of FIG. 1;

FIG. 3 shows an example tracker for use with the hardware acceleration system of FIG. 2;

FIG. 4 shows a system environment for implementing a system for selective execution of workloads using hardware accelerators in accordance with one example;

FIG. 5 shows a computing platform that may be used for performing certain methods in accordance with one example;

FIG. 6 shows a flowchart of a method in accordance with one example; and

FIG. 7 shows another flowchart of a method in accordance with one example.

### DETAILED DESCRIPTION

Examples described in this disclosure relate to selective execution of workloads using hardware accelerators. In certain examples, the methods and systems described herein may be deployed in any virtualized environment, including a single computer (e.g., a single server) or a cluster of computers (e.g., a cluster of servers). In certain examples, the methods and systems described herein may be deployed in cloud computing environments for performance expectation based selective execution of workloads using hardware accelerators. Cloud computing may refer to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

In a virtualized computing environment, client applications are run using virtual machines (or other such virtual environments) hosted by servers. As an example, resources including compute cores, memory, and input/output (IO) resources are allocated to the virtual machines, allowing them to execute client applications using one or more compute cores associated with the respective server(s). Certain workloads, while being able to run on the allocated compute cores, are inefficient for execution by the compute cores due to the compute core architecture and/or the nature of the algorithms used in these workloads. Examples of these workloads include fills, copies, cyclic redundancy check (CRC) generation, compression, decompression, encryption, decryption, etc.

Certain virtualized computing environments include hardware accelerators that can execute these workloads more efficiently. In such a computing environment, many client applications may be executed using virtual machines. Depending upon the client's subscription (or other arrangements), the client applications may be limited in terms of how many compute cores they can access at a given time. Client applications may want to offload certain workloads that can be executed using less power, with higher efficiency, or at a higher performance using hardware accelerators while the compute cores are free to execute other workloads. While such workloads can be executed more efficiently using the hardware accelerators, the decisions regarding whether to offload a particular workload from the compute core to a hardware accelerator are still inefficient. In a virtualized system environment the client applications share resources, including compute cores, memory, and hardware accelerators, client applications can either execute the workload using compute cores allocated to them or offload the workload to an accelerator.

Sharing of the resources, including hardware accelerators, can create delays in the execution of the workload by a hardware accelerator. As an example, a client application could issue work to a hardware accelerator, and that hardware accelerator could be busy enough that it takes longer to complete the work than if the work had been completed using compute cores allocated to the client application. As an example, assuming the client application wants to offload a memory fill operation, the client application may offload that work, not realizing that it would have been better to not offload the memory fill operation. As another example, a client application may be getting ready to initialize a large memory array, and instead of using the compute cores to initialize the memory array, the client application may offload the work to a different hardware accelerator. This offload operation may be executed in a reasonable time and therefore the decision to offload may turn out to be a good decision. Regardless, without proper mechanisms for the client applications to specify a performance expectation for a workload that could be performed by a hardware accelerator, and to know whether the performance expectation will be met, the client applications may often make inefficient choices in terms of the use of the hardware accelerators.

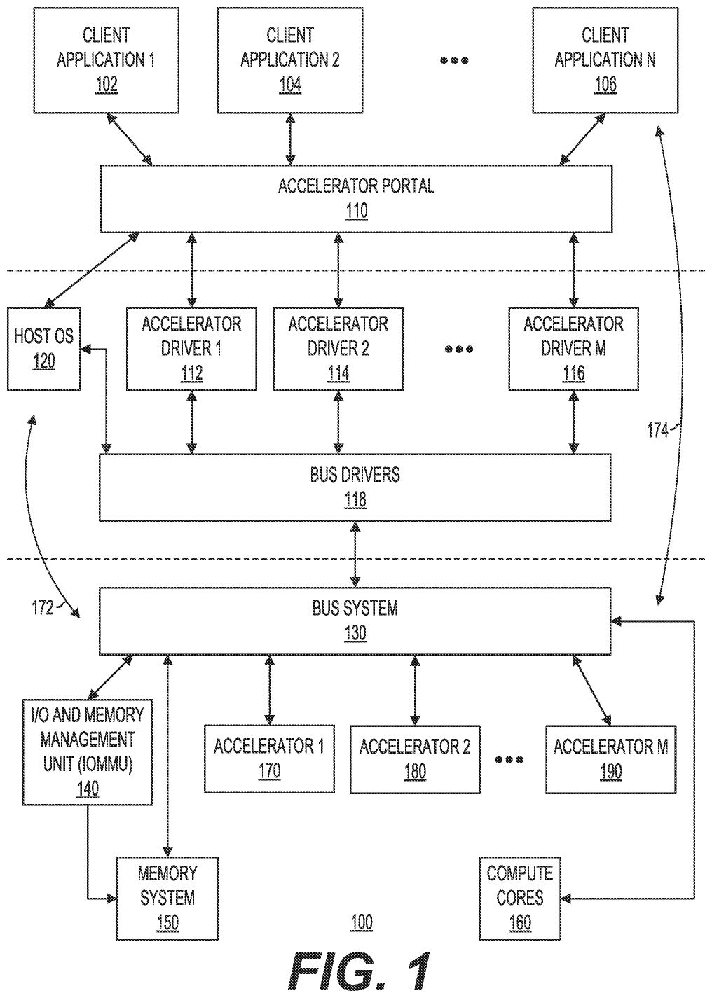

FIG. 1 shows a block diagram of a system 100 for selective execution of workloads using hardware accelerators in accordance with one example. System 100 has example components associated with a virtualized execution environment that includes components for the user space, the kernel space, and the hardware. System 100 allows client applications (e.g., client application 1 (CA1) 102, client application 2 (CA2) 104, and client application N (CAN) 106) to access an accelerator portal 110 and submit workloads directly to the hardware accelerators supported by accelerator portal 110. Accelerator portal 110 is part of the user space allowing access to the client applications, including access to the virtual functions associated with physical functions for the hardware accelerators. Accelerator portal 110 can be configured to allow any of the client applications the ability to access one or more shared hardware accelerators.

As part of kernel space, system 100 further includes accelerator drivers that are coupled to accelerator portal 110. System 100 may include one or more such accelerator drivers, which correspond to respective hardware accelerators included as part of system 100. In this example, system 100 includes accelerator driver 1 112, accelerator driver 2 114, and accelerator driver M 116. System 100 further includes bus drivers 118 that include software drivers corresponding to various bus types, including Peripheral Component Express (PCIe), Compute Express Link (CXL), or other bus types. System 100 further includes a host operating system (OS) 120, which can communicate with the various components of system 100, including accelerator portal 110 and bus drivers 118. Host OS 120 may be any operating system that can support a virtualized environment. In some examples, the functionality associated with host OS 120 may be shared or included as part of a hypervisor (not shown).

With continued reference to FIG. 1, as part of hardware, system 100 includes bus system 130. Bus system 130 may be a PCIe bus system, a CXL bus system, or another type of bus system. Bus system 130 is coupled to an input/output (IO) and memory management unit (IOMMU) 140. Bus system 130 is further coupled with memory system 150, which may further be coupled with IOMMU 140. Memory system 150 may include caches (L1, L2, and/or other system level caches), SRAM, and/or DRAM. IOMMU 140 may provide address translation services, allowing client applications and others to access memory. Memory access may be organized in the form of pages, blocks, or other forms.

Still referring to FIG. 1, bus system 130 is further coupled with compute cores 160. Compute cores 160 may correspond to servers or other computing resources accessible to the client applications. As explained earlier, in a virtualized environment, the compute cores may be shared among many client applications based on the subscriptions by respective client applications to the compute cores. Bus system 130 is further coupled with the hardware accelerators that perform certain workloads that can be offloaded by the client applications to the hardware accelerators. In this example, hardware accelerators include accelerator 1 170, accelerator 2 180, and accelerator M 190. Example hardware accelerators may include the direct streaming accelerator (DSA) from Intel, the quick-assist technology (QAT) accelerator from Intel, the Intel analytics accelerator (IAX), or any other suitable hardware accelerators. Offloaded workloads may include fills, copies, cyclic redundancy check (CRC) generation, compression, decompression, encryption, decryption, etc. In addition, offloaded workloads may be a sequence comprising at least two of aforementioned workloads. As an example, the sequence may include commands directed to any of the workloads described earlier. An example sequence may include the following commands: (1) decrypt, (2) decompress, (3) perform CRC check, (4) compress, (5) encrypt, (6) decrypt, (7) decompress, and (8) perform CRC check. This example sequence relates to recompressing and encrypting data that has been previously encrypted with a different key and compressed using a different codec. Other sequences may also be used.

In terms of the operation of system 100, client applications (e.g., client application 1 (CA1) 102, client application 2 (CA2) 104, and client application N (CAN) 106) can access any hardware acceleration functionality that is offered to them via accelerator portal 110. Any suitable system agent (e.g., the host OS 120 or a hypervisor) is configured to assign virtual functions for a given hardware accelerator to a virtual machine or a similar entity. This allows the client applications the ability to access the virtual functions corresponding to a physical function, which in turn corresponds to a hardware accelerator. The system agent (e.g., host OS 120 or a hypervisor) also maintains knowledge related to the performance of workloads by the compute core(s) assigned to a client application. At any given time, based on historical or real-time performance testing data, host OS 120 can ensure that the client application is aware of the performance that the cores would deliver if the workload were to be executed using the cores. As an example, assuming the workload includes data transfer from one location in the memory to another location in the memory, the client application is aware that such an operation can be performed at 20 GB/second. As further explained below, the trackers associated with the hardware accelerator system can provide performance related information to the client application, allowing the client application to decide whether to have the workload performed using the cores or having the hardware accelerator system execute the workload. Such performance data can also include information concerning the amount of time certain workloads required when performed using the compute cores.

Each virtual function may only be assigned to a single virtual machine (or another type of guest OS or a container) at a time, since virtual functions require real hardware resources associated with a hardware accelerator. A virtual machine can be assigned multiple virtual functions. Virtual functions are derived from physical functions, which may be full PCI Express (PCIe) devices or another type of device. As an example, one or more PCIe devices can be configured per the single-root input/output virtualization (SR-IOV) specification to offer virtual functions corresponding to physical functions. Other abstractions associated with hardware accelerators besides the abstractions of virtual functions and physical functions may also be offered by accelerator portal 110. A system agent (e.g., the host OS 120 or a hypervisor) can configure the specifics for each such assignment, which may relate to the prioritization methodology and the performance in terms of minimum guarantees etc.

Once a virtual function is assigned, the client applications can submit workloads directly to the hardware accelerator having a corresponding physical function that is supported by accelerator portal 110. In system 100, accelerator portal 110 is part of the user space allowing access to the client applications, including access to the virtual functions associated with physical functions for the hardware accelerators. As an example, the client applications executing in the user space can directly submit offloaded workloads to the hardware accelerators via data path 174. Similarly, host OS 120 can directly submit offloaded workloads to the hardware accelerators via data path 172. In one example, the workloads may be submitted using commands that can perform memory mapped I/O operations directly on the hardware accelerators. In other words, the client applications need not rely on interrupts or calls to a driver stack in order to submit the workloads to the hardware accelerators. Moreover, the client applications need not context switch out from the context associated with the compute cores being used to execute the client application at a given time. Advantageously, this arrangement lowers the cost of entry for offloading workloads to the hardware accelerators by reducing the latencies associated with submitting workloads to the accelerators and getting completions back. In addition, in system 100, which includes multiple accelerators, a client application can also issue a command that could be executed by one or more of the accelerators before any attempted execution using a compute core. As an example, a single virtual machine may be assigned one or more virtual functions in each of the two or more hardware accelerators. The VM may submit the workload first to one of the accelerators with a certain performance expectation. If the hardware accelerator responds with a retry command, then the VM may submit the same workload to a different one of the hardware accelerators. Hardware and software associated with hardware acceleration system 200 may be configured to perform load balancing to determine which one of the hardware accelerators should process the resubmitted workload. Similarly, the same functionality may be used to initially assign the workload to a selected one of the hardware accelerators to ensure load balancing.

Commands for performing workloads may be submitted by client applications via data path 174. Such commands will include information related to client specific performance expectation for performing the workload. Such information may be provided as part of a field in the command descriptor for the command. Both posted write commands and non-posted write commands may be used. Posted write commands do not require an acknowledgement indicating that the command was received and has been queued. Instead, the acknowledgement is sent only when the workload processing requested by the posted write command has been completed. Non-posted write commands allow a response back. The response may be a retry response.

Moreover, in some instances additional information, including for example, how busy the hardware accelerator is may also be provided as part of the response. As an example, such information may be provided as part of the completion record once the workload has been executed. The client application may use the received “busy-ness” information to modify its performance expectations from a certain hardware accelerator. The “busy-ness” information may be provided regardless of whether the workload is accepted, rejected, successfully completed, or failed after being accepted. As another example, the hardware accelerator may let the client application know that it has accepted the workload and expects to complete the execution of the workload in a certain amount of time. The client application may use this information to further determine whether to send a request for execution to that hardware accelerator or to another hardware accelerator. As used herein the term “retry response” refers to any type of response that allows the client application to determine whether to execute the workload using a compute core accessible to the client application or let the already submitted command for the workload to be executed by the hardware accelerator. Other commands, including commands that allow atomic command submissions may also be used by the client applications to request workload processing by the hardware accelerators in the system. Although FIG. 1 shows system 100 including a certain number of components, arranged in a certain manner, system 100 may include additional or fewer components arranged differently. As an example, system 100 may include additional or fewer hardware accelerators. As another example, memory management and I/O management tasks may be performed by different components other than integrated components, such as IOMMU 140 of FIG. 1.

As another example, although FIG. 1 describes a virtual computing environment with multiple client applications and multiple hardware accelerators, the methods associated with the disclosure herein may be executed even in a scenario where there is only one hardware accelerator and only one queue for the hardware accelerator. In such a scenario, simpler performance measurement systems than described later may be used. As an example, a heartbeat signal from the single hardware accelerator may be sufficient as a basis for providing a response to the client application that workload execution is progressing. Thus, in such a scenario, the performance expectation set by the client application may simply be whether the hardware accelerator is making progress with respect to existing workloads. Alternatively, the performance expectation set by the client application may be whether the hardware accelerator is failing to make progress with respect to the execution of the existing workloads already in the queue for the hardware accelerator.

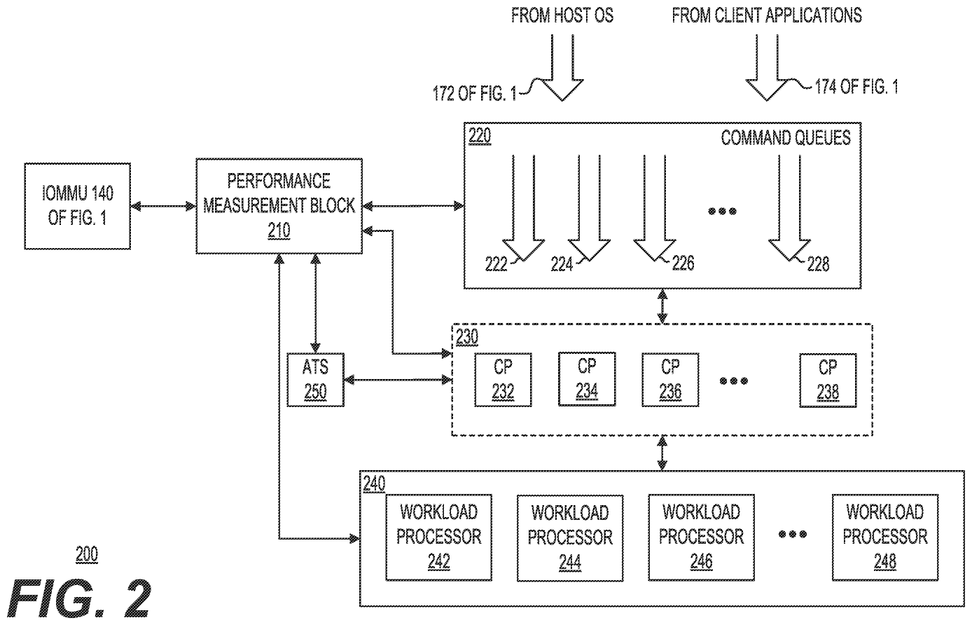

FIG. 2 shows a block diagram of an example hardware acceleration system (HAS) 200 for use with the system 100 of FIG. 1. HAS 200 includes a performance measurement block 210 coupled with command queues 220. Performance measurement block 210 is further coupled with IOMMU 140 of FIG. 1. In addition, performance measurement block 210 is coupled with accelerator 240, which may be any one of the hardware accelerators described earlier with respect to FIG. 1. Each hardware accelerator may have a dedicated performance measurement block or such blocks may be shared among the hardware accelerators. Command queues 220 may receive commands from client applications of FIG. 1 via data path 174 of FIG. 1. Command queues 220 may also receive commands from host OS 120 of FIG. 1 via data path 172. In one example, command queues 220 may be implemented using first-in-first-out (FIFO) buffers. Command queues 220 may also receive commands from host OS 120 of FIG. 1 via data path 172.

Command queues 220 may include shared queues for a particular hardware accelerator. Some of the command queues may be dedicated queues for a hardware accelerator. Some command queues may be configured to process high priority workloads, whereas some other command queues may be configured to process regular priority workloads. Certain command queues may be intended for larger workloads and some of the command queues may be intended for smaller workloads. This arrangement may help reduce the completion latency associated with the workloads. Command queues may also be configured such that there are no command queues that are shared among different types of accelerators. As an example, a compressor accelerator may not share any command queues with a decryption accelerator. Accumulators associated with each command queue may include a size of the respective command queue. As commands are submitted for execution, the accumulator may be decremented. As additional commands arrive, the accumulator may be incremented. At any given time, the accumulator for each command queue will have a running count of the number of commands still in the command queue.

As explained earlier, client applications can access the virtual functions corresponding to a physical function, which in turn corresponds to a hardware accelerator. In one example, HAS 200 supports input command queues that are provided command descriptors using atomic 64 B writes. The command submissions can be atomic submissions, in that the atomic command submission comes across an interface as one transaction and no other commands can be performed during the performance of the atomic command submission. Thus, the 64 B write atomic submission is performed in its entirety before other read/write operations can be performed using the resources allocated to the 64 B write atomic submission. Each command queue operates as an independent FIFO for the command descriptors within it.

In one example, each hardware accelerator is assumed to have one physical function per device, up to 32 virtual functions per device, up to four command queues per PF/VF, and up to 4000 queue entries per device. Indeed, a different number of physical functions/virtual functions may be configured per device. Each PF, VF, and queue can be identified by a unique identifier. Although not shown in FIG. 2, a device driver can partition resources according to the VF, and a function driver can partition resources for the queues that each VF wants to support. Thus, the device driver can set up and configure a respective hardware accelerator as a whole and a function driver can handle the configuration and attributes and quality of service settings for a given VF portal. As an example, the device driver can allocate the base and total number of entries per PV/VF for the command queue memory. The device driver can also allocate the number of command queue tracking resources per VF that are available. The function driver can read configuration registers to determine its allocation of queue trackers and queue memory. The function driver can also program the number of command queues it wants to use and to allocate the base and size for each queue in its allocated command queue memory space.

HAS 200 further includes a block of command processors 230. In this example, the block of command processors 230 includes command processor (CP) 232, CP 234, CP 236, and CP 238. HAS 200 further includes a block of workload processors 240. In this example, the block of workload processors 240 includes workload processor (WP) 242, WP 244, WP 246, and WP 248. HAS 200 further includes an address translation service 250. Any of the command processors can access address translation services (ATS) 250 and any of the workload processors in the block of workload processors 240. Thus, any of the command processors initiates the translation of virtual addresses to physical addresses, obtains such translations, and then calls any of the workload processors for the performance of the workload. In one example, each workload has a size of 4 kilobytes (KB). The workload size may be selected to have the same granularity as the one supported by the host OS for address translation purposes. Each workload processor can be viewed as having at least the functionality associated with a DMA engine, in that it can independently initiate memory reads, perform the acceleration function (if it requires more than just copying or moving), and then perform memory writes, as required. Workload processors are assigned to process a workload after an arbitration process is completed. Although FIG. 2 shows HAS 200 including a certain number of components, arranged in a certain manner, HAS 200 may include additional or fewer components arranged differently. As an example, HAS 200 may include additional or fewer command queues, additional or fewer command processors, and additional or fewer workload processors. As another example, memory management and I/O management tasks may be performed by different components other than integrated components, such as IOMMU 140 of FIG. 1.

Performance measurement block 210 includes trackers for tracking performance. For each client application and each command queue, there are separate and independent trackers for performance tracking. Thus, a tracker can be configured to track an absolute performance (e.g., N megabytes (MB)/second) of bandwidth of a transaction bus associated with accelerators or a relative performance (e.g., percentage of the bandwidth). Broadly speaking, a tracker has an input signal that will be high for every clock (or a certain number of clocks) that a condition being tracked occurs. For minimum performance, that condition could be when a workload unit is performed. For maximum performance (e.g., maximum bandwidth), that condition could be a write or read data strobe. The tracker has another input signal that will be high for every clock (or a certain number of clocks) whenever the condition being tracked against occurs. For absolute performance, this input signal is either always 1 when counting system clocks or a pulse train that tracks a divided down version of that clock. For relative performance, this input signal can be whenever any transaction occurs, not just the ones that are being tracked.

Every time the condition being tracked occurs, a programmed value is used to increment the tracking level. Every time the condition not being tracked against occurs (for relative tracking) or a coarse clock quanta transpires (for absolute tracking), another programmed value is used to decrement the tracking level. If the items being tracked are occurring at the desired rate, the tracker level will remain at the same level. If the items being tracked are occurring at a rate higher than the desired rate, then the tracker level will rise. If the items being tracked are occurring at a rate lower than the desired rate, then the tracker level will fall. Clamping can be used to avoid overflow and underflow conditions for these increment/decrement operations. In addition, the trackers support programmable duty cycle asymmetry (indicative of the burstiness of work), excursion tracking (indicative of how far off the specified rate is tracked), and assertion levels (indicative of at what point does one raise the alarm about being off the specified rate).

The same tracker design can be used for tracking the minimum rates or the maximum rates. An input strap can be used to select between the two modes of operation. The tracker has an output signal indicating whether the tracker level has fallen below the minimum level (when configured to track the minimum rate) or has risen above the maximum level (when configured to track the maximum rate). This level is determined by a configuration register. As an example, a 16-bit value for this level and tracker precision can be used. Upon a reset, the trackers can be reset to midrange or can be set to a programmed level. The total dynamic range of the tracker level is determined by the tracker level precision and the increment/decrement levels. The longer the time period over which one wants to average out the performance, the smaller the increment levels should be to support a larger dynamic range before clamping.

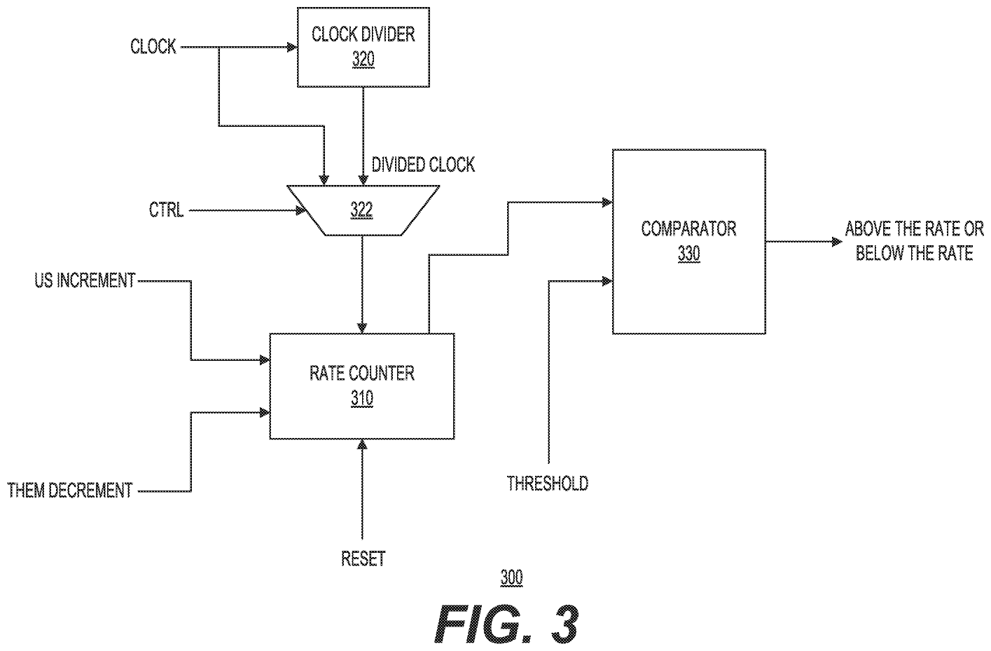

FIG. 3 shows an example tracker 300 for use with the hardware acceleration system (HAS) 200 of FIG. 1. In this example, tracker 300 includes a rate counter 310, a clock divider 320, and a comparator 330. In addition, tracker 300 includes a multiplexer 320, which allows either the clock signal or the divided clock signal for use with the rate counter 310. Rate counter 310 may be a 16-bit counter that can be reset to a value that is the same as the threshold value. Configuration registers (not shown) can be used to store those values for the tracker 300 that can be programmed depending on the tracker's purpose in terms of what conditions are being tracked (e.g., conditions based on bus transactions, address translation service related transactions, memory usage, or some other aspect).

The data related to the conditions being tracked may be obtained from the specific resource monitoring corresponding to the architecture associated with the compute cores. As an example, compute cores may be ARM cores or x86 compatible cores. If the compute cores are ARM cores, then ARM architecture additions related to resource monitoring, such as memory partitioning and monitoring (MPAM) may provide the data related to the conditions being tracked. As an example, MPAM may provide data related to the bandwidth consumption associated with the transactions on the bus (e.g., bus system 130 of FIG. 1). If the compute cores are x86 cores, then Intel architecture related aspects for resource monitoring may provide the data related to the conditions being tracked. As an example, memory bandwidth monitoring (MBM) offered by Intel may be used to track data related to the bandwidth consumption associated with the transactions on the bus (e.g., bus system 130 of FIG. 1). Other more extensive resource monitoring hardware/software systems may be used to collect the data relevant to the conditions being tracked by each tracker (e.g., tracker 300).

The US INCREMENT signal corresponds to a signal indicating a condition that is being tracked as time is passing. The THEM DECREMENT signal corresponds to a clock signal (or a clock divider signal) if an absolute value is being tracked. Thus, if one is trying to hit a given rate of consumption of a resource and the increment and the decrement values have been configured to track the deviation from the given rate then the rate counter value stays about the same. Overtime, occasionally the rate counter value may increase and then decrease based on activity and time, but the general level will stay about the same. The specific values chosen for the increment and the decrement related signals define the dynamic range of tracker 300. As an example, if the tracker is being used to track the memory bandwidth, then one could increment rate counter 310 for every bus transaction (e.g., a 64-byte (64 B) transaction) or choose a different level of granularity. As an example, assuming the hardware accelerators are working on four kilobyte (4 KB) workloads, then rather than incrementing rate counter 310 for every bus transaction, rate counter 310 is incremented every single time a 4 KB worth of bus transactions have been completed.

The THEM DECREMENT signal may correspond to a clock signal (e.g., the clock signal CLOCK or a divided version of the clock signal DIVIDED CLOCK) indicating the passage of time. The THEM DECREMENT signal may also correspond to a signal that is for the same condition that is being tracked in a relative manner as the time is passing.

The output of rate counter 310 is compared against a threshold (e.g., THRESHOLD shown in FIG. 3) using comparator 330. If the tracker 300 is being used to track against the maximum usage, then the threshold value may be set as the maximum usage value configured for a resource (e.g., maximum bandwidth usage). The output of comparator 330 indicates whether the rate of usage is above the maximum rate or some other targeted rate (e.g. ABOVE THE RATE). On the other hand, if the tracker 300 is being used to track against the minimum usage, then the threshold value may be set as the minimum usage value configured for a resource (e.g., minimum bandwidth usage). The output of comparator 330 indicates whether the rate of usage is below the minimum rate or some other targeted rate (e.g. BELOW THE RATE). Although FIG. 3 shows tracker 300 including a certain number of components, arranged in a certain manner, tracker 300 may include additional or fewer components arranged differently.

In one example, there is a minimum performance tracker for each VF. The tracker counts 64 B quanta of work performed by all commands from all queues for a given VF. Work could entail only read operations (like for CRC generation), only write operations (like for fill), or both (like for copy). For a copy command, 64 B of data that is read and then written can be configured to represent one quanta of work or 2 quanta. In this example, there is a minimum performance tracker for each queue within a VF. This tracker has the same function as the VF minimum tracker, but observes traffic from only that specified VF queue.

In one example, there are two maximum bandwidth trackers, one for read operations and one for write operations. The trackers track 64 B quanta of payload for all commands from all queues for a given VF. Moreover, in this example, there are two maximum bandwidth trackers for each queue, one for read operations and one for write operations. The trackers track 64 B quanta of payload for all commands from that specified queue. In addition, in this example, there is another set of trackers per VF and per queue which track the rate of address translation service (ATS) transactions used by given resources.

In sum, the trackers associated with the hardware accelerator system can provide performance related information to the client application, allowing the client application to decide whether to have the workload performed using the cores or having the hardware accelerator system execute the workload. Such performance data can also include information concerning the amount of time certain workloads required when performed using the compute cores. In another example, the hardware accelerator can be provided with an expectation of maximum time that an accelerator will need in the command submission itself. Thus, if the command queues are too full and the command submission will be delayed because of the fullness of the queues, the client application may perform the workload using the compute cores. As explained earlier, once the hardware accelerator determines that the performance expectation (e.g., how long would it take before a given command can be completed) specified by the client application cannot be met, then the hardware accelerator simply lets the client application know. As an example, if the hardware accelerator believes that the command will take longer, it simply returns a “Retry” status, and the client can execute the command on its own available compute cores. Otherwise, the command is accepted and the accelerator performs the work. The trackers can also be configured to keep track of the maximum time that a hardware accelerator will need as part of the command submission process itself.

The response may include additional information than just retry, including for example, how busy the hardware accelerator is. This is because HAS 200 of FIG. 2 includes performance measurement functionality integrated into the design, hence supporting these mechanisms is possible. As an example, performance measurement block 210 of FIG. 2 can perform calculations to determine how busy the hardware accelerator is by determining the number of submitted command descriptors in the command queues and the tracked performance of the workload processors associated with the hardware accelerator. Alternatively, performance measurement block 210 may determine whether the hardware accelerator is busy by simply tracking the number of client applications that have workloads that are being processed by the hardware accelerator. If the number of such client applications at a given time is greater than a predetermined threshold, then the hardware accelerator may be deemed busy.

Additionally, there are numerous “tiers” of support possible based on hardware implementations. Instead of an indication of how much time an accelerator is allowed to complete a workload, the same mechanisms can be used to indicate queue fullness criteria (e.g., retry if you already have greater than N entries in the queue), queue workload criteria (e.g., retry if you already have greater than N KB of work submitted in the queue), accelerator fullness criteria (e.g., retry if you already have greater than N entries with higher or equal priority submitted across the various queues), accelerator workload criteria (e.g., retry if you already have greater than N KB of work submitted across the various queues), workload completion estimation (e.g., based on current performance, how long to complete workload), or some combination of the above.

In one example, the commands may be non-posted write commands that allow a response back. The command itself will have a field that would indicate how much time the client application expects the hardware accelerator to take to execute the workload specified by the command. As an example, with respect to the Intel DSA system, the command may be a modified version of the enqueue command (ENQCMD). The response will be a retry response if the hardware accelerator cannot complete the workload in the expected span of time. Alternatively, the command will be accepted by the hardware accelerator and will be executed. Upon receiving the retry response, the client application will not submit the workload to the hardware accelerator system and instead will execute the workload using the compute cores assigned to the client application. As another example, with respect to the ARM-based accelerator, the command may be a modified version of ST64 command. Other commands, including commands that allow atomic command submissions, may also be used by the client applications to request workload processing by the hardware accelerators in the system.

Instead of non-posted commands, posted commands may be used with a dedicated direct queue submission arrangement. Posted write commands do not require an acknowledgement indicating that the command was received and has been queued. Instead, the acknowledgement is sent only when the workload processing requested by the posted write command has been completed. Posted command submissions are usually not the preferred method for command submissions because of the higher latency. In the context of this disclosure, however, even posted commands could be used since such commands could be intercepted by the performance measurement block 210 of FIG. 2 (or a similar arrangement) to make similar determinations as explained above with respect to the non-posted write commands.

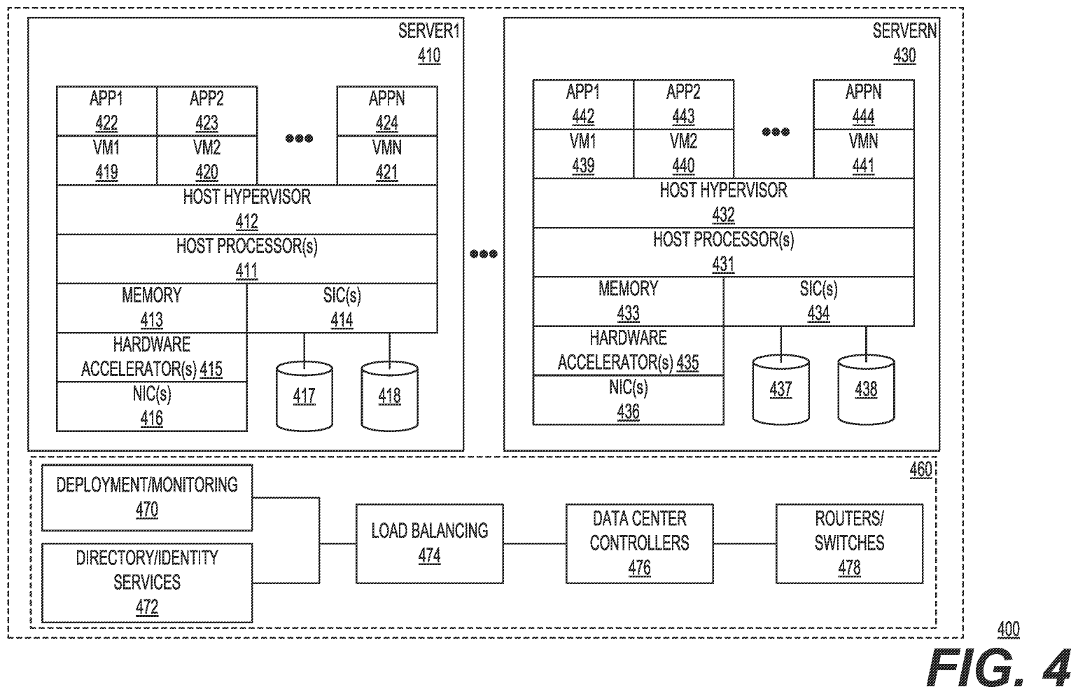

FIG. 4 shows a system environment 400 for implementing systems and methods in accordance with one example. In this example, system environment 400 may correspond to a portion of a data center. As an example, the data center may include several clusters of racks including platform hardware, such as server nodes, storage nodes, networking nodes, or other types of nodes. Server nodes may be connected to switches to form a network. The network may enable connections between each possible combination of switches. System environment 400 may include server1 410 and serverN 430. System environment 400 may further include data center related functionality 460, including deployment/monitoring 470, directory/identity services 472, load balancing 474, data center controllers 476 (e.g., software defined networking (SDN) controllers and other controllers), and routers/switches 478. Server1 410 may include host processor(s) 411, host hypervisor 412, memory 413, storage interface controller(s) (SIC(s)) 414, accelerator(s) 415 (e.g., the accelerators described earlier), network interface controller(s) (NIC(s)) 416, and storage disks 417 and 418. ServerN 430 may include host processor(s) 431, host hypervisor 432, memory 433, storage interface controller(s) (SIC(s)) 434, accelerator(s) 435 (e.g., the accelerators described earlier), network interface controller(s) (NIC(s)) 436, and storage disks 437 and 438. Server1 410 may be configured to support virtual machines, including VM1 419, VM2 420, and VMN 421. The virtual machines may further be configured to support applications, such as APP1 422, APP2 423, and APPN 424. ServerN 430 may be configured to support virtual machines, including VM1 439, VM2 440, and VMN 441. The virtual machines may further be configured to support applications, such as APP1 442, APP2 443, and APPN 444.

With continued reference to FIG. 4, in one example, system environment 400 may be enabled for multiple tenants using the Virtual eXtensible Local Area Network (VXLAN) framework. Each virtual machine (VM) may be allowed to communicate with VMs in the same VXLAN segment. Each VXLAN segment may be identified by a VXLAN Network Identifier (VNI). Although FIG. 4 shows system environment 400 as including a certain number of components arranged and coupled in a certain way, it may include fewer or additional components arranged and coupled differently.

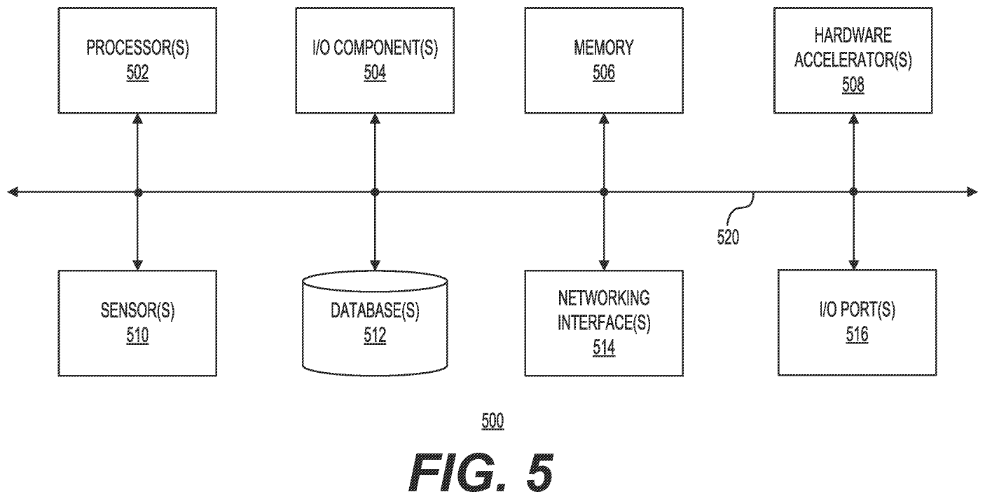

FIG. 5 shows a block diagram of a computing platform 500 (e.g., for implementing certain aspects of the methods and algorithms associated with the present disclosure) in accordance with one example. Computing platform 500 may include a processor(s) 502, I/O component(s) 504, memory 506, hardware accelerator(s) 508, sensor(s) 510, database(s) 512, networking interface(s) 514 and I/O Port(s), which may be interconnected via bus 520. Processor(s) 502 may execute instructions stored in memory 506. I/O component(s) 504 may include user interface devices such as a keyboard, a mouse, a voice recognition processor, touch screens, or displays. Memory 506 may be any combination of non-volatile storage or volatile storage (e.g., flash memory, DRAM, SRAM, or other types of memories). Hardware accelerator(s) 508 may include any of the hardware accelerators described earlier.

Sensor(s) 510 may include telemetry or other types of sensors configured to detect, and/or receive, information (e.g., conditions associated with the devices). Sensor(s) 510 may include sensors configured to sense conditions associated with CPUs, memory or other storage components, FPGAs, motherboards, baseboard management controllers, or the like. Database(s) 512 may be used to store data used for generating reports related to execution of the workloads using cores associated with processor(s) 502 or hardware accelerator(s) 508.

Networking interface(s) 514 may include communication interfaces, such as Ethernet, cellular radio, Bluetooth radio, UWB radio, or other types of wireless or wired communication interfaces. I/O port(s) may include Ethernet ports, InfiniBand ports, Fiber Optic port(s), or other types of ports. Although FIG. 5 shows computing platform 500 as including a certain number of components arranged and coupled in a certain way, it may include fewer or additional components arranged and coupled differently. In addition, the functionality associated with computing platform 500 may be distributed, as needed.

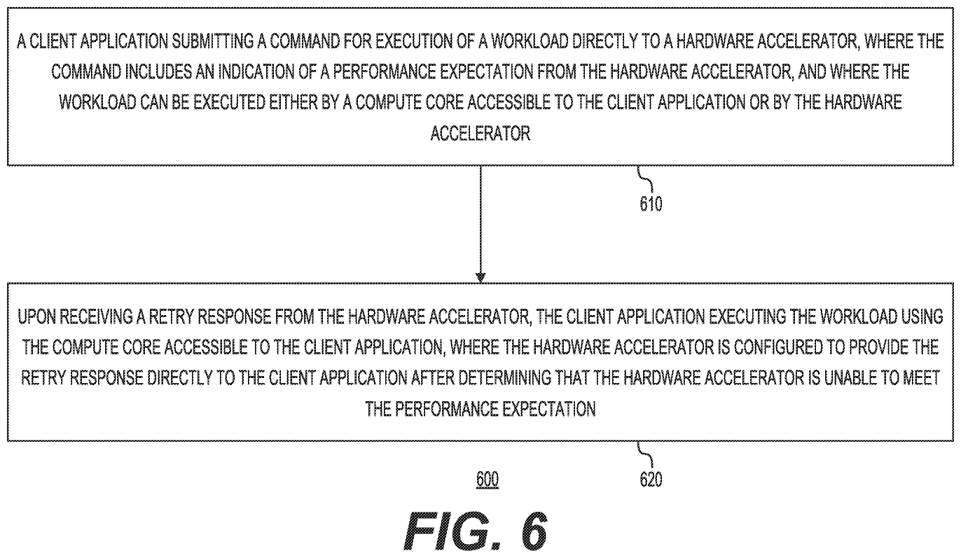

FIG. 6 shows a flowchart 600 of a method in accordance with one example. Step 610 may include a client application submitting a command for execution of a workload directly to a hardware accelerator, where the command includes an indication of a performance expectation from the hardware accelerator, and where the workload can be executed either by a compute core accessible to the client application or by the hardware accelerator. In one example, this method may be performed using one or more components associated with system 100 of FIG. 1. Any of the client applications 102, 104, or 106 may submit the command for execution of the workload directly (e.g., via path 174 of FIG. 1) to any of the hardware accelerators (e.g., accelerator 1 170, accelerator 2 180, or accelerator M 190 of FIG. 1). As explained earlier, the command may include an indication of a performance expectation from the hardware accelerator. The performance expectation may include an amount of time it would take for the hardware accelerator to execute the workload. Alternatively, or additionally, the performance expectation may include an expectation of a maximum time that the hardware accelerator needs for a command submission itself.

The hardware accelerator may comprise command queues and the performance expectation may include a fullness criteria or a workload criteria associated with one or more of the command queues. The hardware accelerator may allow client applications to access virtual functions for at least one physical function associated with the hardware accelerator, and the performance expectation may be a fullness criteria or a workload criteria associated with one or more of the virtual functions. The performance expectation may also be a fullness criteria or a workload criteria associated with the hardware accelerator itself.

Step 620 may include upon receiving a retry response from the hardware accelerator, the client application executing the workload using the compute core accessible to the client application, where the hardware accelerator is configured to provide the retry response directly to the client application after determining that the hardware accelerator is unable to meet the performance expectation. As explained earlier, the commands may be non-posted write commands that allow a response back. The command itself will have a field that would indicate how much time the client application expects the hardware accelerator to take to execute the workload specified by the command. As an example, with respect to the Intel DSA system, the command may be a modified version of the enqueue command (ENQCMD). The response will be a retry response if the hardware accelerator cannot complete the workload in the expected span of time. Alternatively, the command will be accepted by the hardware accelerator and will be executed. Upon receiving the retry response, the client application will not submit the workload to the hardware accelerator system and instead will execute the workload using the compute cores assigned to the client application. Advantageously, this method lowers the cost of entry for offloading workloads to the hardware accelerators by reducing the latencies associated with submitting workloads to the accelerators and getting completions back. As an example, in a system in which the client application needs to read (or otherwise obtain) performance data before deciding to offload the workload, there is a latency associated with waiting to receive the reply. Using the aforementioned method, the client application can submit the workload, and only if the client application's workload cannot be executed by the hardware accelerator within the criteria related to the performance expectation does the client application receive a “retry” reply, otherwise the workload is simply executed by the hardware accelerator. Thus, in many instances the latency associated with offloading workloads to hardware accelerators is advantageously lowered even more. Because of the lowered overhead (e.g., lowered latencies) associated with these methods and systems, one can offload even smaller workloads.

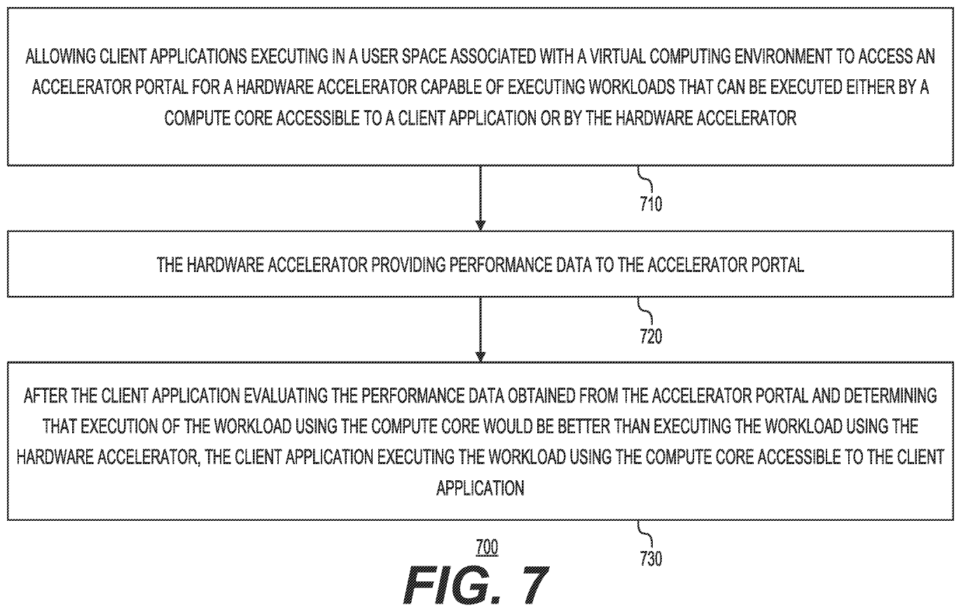

FIG. 7 shows a flowchart 700 of a method in accordance with one example. Step 710 may include allowing client applications executing in a user space associated with a virtual computing environment to access an accelerator portal for a hardware accelerator capable of executing workloads that can be executed either by a compute core accessible to a client application or by the hardware accelerator. As shown in FIG. 1, accelerator portal 110 may be configured such that the client applications (e.g., client application 1 102, client application 2 104, and client application N 106 of FIG. 1) can access the accelerator portal.

Step 720 may include the hardware accelerator providing performance data to the accelerator portal. Any of the hardware accelerators shown in FIG. 1 may provide the performance data to the accelerator portal. The performance data may be the various types of performance related data described earlier, such that it can help the client application determine whether to offload the workload to the hardware accelerator or perform the workload using the compute cores accessible to the client application.

Step 730 may include after the client application evaluating the performance data obtained from the accelerator portal and determining that execution of the workload using the compute core would be better than executing the workload using the hardware accelerator, the client application executing the workload using the compute core accessible to the client application. As described earlier, the client application may make the evaluation by comparing data related to the performance of the compute cores accessible to it and the performance data provided by the hardware accelerator. As an example, the client application may determine that it would take less time for the workload to be executed using the compute cores accessible to it than it would using the hardware accelerator. Advantageously, this method also lowers the cost of entry for offloading workloads to the hardware accelerators by reducing the latencies associated with submitting workloads to the accelerators and getting completions back.

In conclusion, the present disclosure relates to a method comprising a client application submitting a command for execution of a workload directly to a hardware accelerator, where the command includes an indication of a performance expectation from the hardware accelerator, and where the workload can be executed either by a compute core accessible to the client application or by the hardware accelerator. The method may further include upon receiving a retry response from the hardware accelerator, the client application executing the workload using the compute core accessible to the client application, where the hardware accelerator is configured to provide the retry response directly to the client application after determining that the hardware accelerator is unable to meet the performance expectation.

The method may further include the hardware accelerator executing the workload instead of providing the retry response to the client application after determining that the hardware accelerator is able to meet the performance expectation. The performance expectation may comprise an amount of time it would take for the hardware accelerator to execute the workload. The performance expectation may comprise a maximum time that the hardware accelerator needs for a command submission itself.

The hardware accelerator comprises command queues and the performance expectation may comprise a fullness criteria or a workload criteria associated with one or more of the command queues. The hardware accelerator allows client applications to access virtual functions for at least one physical function associated with the hardware accelerator and the performance expectation may comprise a fullness criteria or a workload criteria associated with one or more of the virtual functions.

The performance expectation may comprise a fullness criteria or a workload criteria associated with the hardware accelerator. The workload may comprise a copy workload, a fill workload, an encryption workload, a decryption workload, a compression workload, a decompression workload, a cyclic redundancy check (CRC) generation workload, or a sequence comprising at least two of aforementioned workloads.

In another aspect, the present disclosure relates to a method comprising allowing client applications executing in a user space associated with a virtual computing environment to access an accelerator portal for a hardware accelerator capable of executing workloads that can be executed either by a compute core accessible to a client application or by the hardware accelerator. The method may further include the hardware accelerator providing performance data to the accelerator portal.

The method may further include, after the client application evaluating the performance data obtained from the accelerator portal and determining that execution of the workload using the compute core would take less time than executing the workload using the hardware accelerator, the client application executing the workload using the compute core accessible to the client application.

The method may further include the hardware accelerator executing the workload after the client application evaluates the performance data obtained from the accelerator portal and determines that execution of the workload using the compute core would be worse than executing the workload using the hardware accelerator. The accelerator portal may be in the user space and is configurable to provide access to virtual functions and physical functions associated with a plurality of hardware accelerators.

The workload may comprise a copy workload, a fill workload, an encryption workload, a decryption workload, a compression workload, a decompression workload, a cyclic redundancy check (CRC) generation workload, or a sequence comprising at least two of aforementioned workloads.

In yet another aspect, the present disclosure relates to a system comprising an accelerator portal to allow a plurality of client applications access to one or more of a plurality of shared hardware accelerators, where each of the plurality of client applications can execute a workload using a compute core or by using one of the plurality of shared hardware accelerators. The system may further include a hardware accelerator, from among the plurality of shared hardware accelerators, configured to receive from a client application a command for execution of a workload via a shared bus system coupled to the compute cores and the plurality of shared hardware accelerators, where the command includes an indication of a performance expectation from the hardware accelerator, and where the workload can be executed either by a compute core accessible to the client application or by the hardware accelerator.

The client application may be configured to execute the workload using the compute core accessible to the client application upon receiving a retry response from the hardware accelerator, where the hardware accelerator is configured to provide the retry response directly to the client application after determining that the hardware accelerator is unable to meet the performance expectation.

The hardware accelerator may be configured to execute the workload instead of providing the retry response to the client application after determining that the hardware accelerator is able to meet the performance expectation. The performance expectation may comprise an amount of time it would take for the hardware accelerator to execute the workload. The performance expectation may comprise a maximum time that the hardware accelerator needs for a command submission itself.

The hardware accelerator allows client applications to access virtual functions for at least one physical function associated with the hardware accelerator and the performance expectation may comprise a fullness criteria or a workload criteria associated with one or more of the virtual functions. The hardware accelerator comprises command queues and the performance expectation may comprise a fullness criteria or a workload criteria associated with one or more of the command queues. The performance expectation may comprise a fullness criteria or a workload criteria associated with the hardware accelerator.

Each of the plurality of shared hardware accelerators comprises a plurality of command queues. Each of the plurality of command queues may have an associated tracker for tracking at least one performance criteria associated with a respective queue. The workload may comprise a copy workload, a fill workload, an encryption workload, a decryption workload, a compression workload, a decompression workload, a cyclic redundancy check (CRC) generation workload, or a sequence comprising at least two of aforementioned workloads.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from but can be used in conjunction with transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method comprising:
a client application submitting a command for execution of a workload directly to a hardware accelerator, wherein the command includes an indication of a performance expectation from the hardware accelerator, and wherein the workload can be executed either by a compute core accessible to the client application or by the hardware accelerator; and
upon receiving a retry response from the hardware accelerator, the client application executing the workload using the compute core accessible to the client application, wherein the hardware accelerator is configured to provide the retry response directly to the client application after determining that the hardware accelerator is unable to meet the performance expectation.

2. The method of claim 1, further comprising the hardware accelerator executing the workload instead of providing the retry response to the client application after determining that the hardware accelerator is able to meet the performance expectation.

3. The method of claim 1, wherein the performance expectation comprises an amount of time it would take for the hardware accelerator to execute the workload.

4. The method of claim 1, wherein the performance expectation comprises a maximum time that the hardware accelerator needs for a command submission itself.

5. The method of claim 1, wherein the hardware accelerator comprises command queues, and wherein the performance expectation comprises a fullness criteria or a workload criteria associated with one or more of the command queues.

6. The method of claim 1, wherein the hardware accelerator allows client applications to access virtual functions for at least one physical function associated with the hardware accelerator, and wherein the performance expectation comprises a fullness criteria or a workload criteria associated with one or more of the virtual functions.

7. The method of claim 1, wherein the performance expectation comprises a fullness criteria or a workload criteria associated with the hardware accelerator.

8. The method of claim 1, wherein the workload comprises a copy workload, a fill workload, an encryption workload, a decryption workload, a compression workload, a decompression workload, a cyclic redundancy check (CRC) generation workload, or a sequence comprising at least two of aforementioned workloads.

9. A method comprising:
allowing client applications executing in a user space associated with a virtual computing environment to access an accelerator portal for a hardware accelerator capable of executing workloads that can be executed either by a compute core accessible to a client application or by the hardware accelerator;
the hardware accelerator providing performance data to the accelerator portal; and
after the client application evaluating the performance data obtained from the accelerator portal and determining that execution of the workload using the compute core would be better than executing the workload using the hardware accelerator, the client application executing the workload using the compute core accessible to the client application.

10. The method of claim 9, further comprising the hardware accelerator executing the workload after the client application evaluates the performance data obtained from the accelerator portal and determines that execution of the workload using the compute core would be worse than executing the workload using the hardware accelerator.

11. The method of claim 9, wherein the accelerator portal is in the user space and is configurable to provide access to virtual functions and physical functions associated with a plurality of hardware accelerators.

12. The method of claim 9, wherein the workload comprises a copy workload, a fill workload, an encryption workload, a decryption workload, a compression workload, a decompression workload, a cyclic redundancy check (CRC) generation workload, or a sequence comprising at least two of aforementioned workloads.

13. A system comprising:
an accelerator portal to allow a plurality of client applications access to one or more of a plurality of shared hardware accelerators, wherein each of the plurality of client applications can execute a workload using a compute core or by using one of the plurality of shared hardware accelerators;
a hardware accelerator, from among the plurality of shared hardware accelerators, configured to receive from a client application a command for execution of a workload via a shared bus system coupled to the compute cores and the plurality of shared hardware accelerators, wherein the command includes an indication of a performance expectation from the hardware accelerator, and wherein the workload can be executed either by a compute core accessible to the client application or by the hardware accelerator; and
the client application configured to execute the workload using the compute core accessible to the client application upon receiving a retry response from the hardware accelerator, wherein the hardware accelerator is configured to provide the retry response directly to the client application after determining that the hardware accelerator is unable to meet the performance expectation.

14. The system of claim 13, wherein the hardware accelerator is configured to execute the workload instead of providing the retry response to the client application after determining that the hardware accelerator is able to meet the performance expectation.

15. The system of claim 13, wherein the performance expectation comprises an amount of time it would take for the hardware accelerator to execute the workload.

16. The system of claim 13, wherein the performance expectation comprises a maximum time that the hardware accelerator needs for a command submission itself.

17. The system of claim 13, wherein the hardware accelerator allows client applications to access virtual functions for at least one physical function associated with the hardware accelerator, and wherein the performance expectation comprises a fullness criteria or a workload criteria associated with one or more of the virtual functions.

18. The system of claim 13, wherein the hardware accelerator comprises command queues, and wherein the performance expectation comprises a fullness criteria or a workload criteria associated with one or more of the command queues.

19. The system of claim 13, wherein the performance expectation comprises a fullness criteria or a workload criteria associated with the hardware accelerator.

20. The system of claim 13, wherein each of the plurality of shared hardware accelerators comprises a plurality of command queues.

21. The system of claim 19, wherein each of the plurality of command queues has an associated tracker for tracking at least one performance criteria associated with a respective queue.

22. The system of claim 13, wherein the workload comprises a copy workload, a fill workload, an encryption workload, a decryption workload, a compression workload, a decompression workload, a cyclic redundancy check (CRC) generation workload, or a sequence comprising at least two of aforementioned workloads.
